(19) United States
(12) Patent Application Publication
(10) Pub. No.: US 2009/0167804 A1
(43) Pub. Date: Jul. 2, 2009

(54) IMAGE FORMING METHOD AND INKJET RECORDING APPARATUS USING THE METHOD

(76) Inventors: Naoki KIKUCHI, Kanagawa (JP); Masanori Hirano, Kanagawa (JP); Masakazu Yoshida, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/337,011

(22) Filed: Dec. 17, 2008

(30) Foreign Application Priority Data
Dec. 28, 2007 (JP) 2007-338521

(51) Int. Cl. B41J 2/205

(52) U.S. Cl. 347/15

(57) ABSTRACT

An image forming method is disclosed in an inkjet recording apparatus, which uses L (L≧1) kinds of ink, includes a recording head capable of ejecting “n” sizes of ink droplets M[n] (n≧1), and records an image on a recording medium by separating a tone forming region on the recording medium when the sizes of the ink droplets are determined to be M[1], M[2], . . . in order from the smallest size. When beading is generated by ink droplets M[i] (i≧1) or more, the method includes the steps of forming a halftone pattern by arraying dots of the ink droplets in a mesh type or a line type with a fixed pitch in the ink droplets M[j] (j≧i), and not ejecting the ink droplets M[j] onto all pixel positions of the recording medium other than the positions of the halftone pattern.

### BACKGROUND OF THE INVENTION

1. Field of the Invention The present invention generally relates to an image forming method and an inkjet recording apparatus using the method in which a dot pattern is arbitrarily selected corresponding to a size of ink droplets ejected from a recording head.

2. Description of the Related Art

Conventionally, as an image forming apparatus such as a printer, a facsimile machine, a copier, and a multifunctional apparatus that has the above functions, an inkjet recording apparatus is well known which uses a liquid droplet ejecting head as a recording head.

The inkjet recording apparatus forms an image on a recording medium (paper) by ejecting ink (recording liquid) onto the recording medium from a recording head. The recording medium is not limited to paper and can be a material to which an ink droplet and other liquid droplets can be adhered, for example, an OHP sheet. The image forming includes image recording, image printing, letter printing, letter transferring and so on.

As paper which is used in the inkjet recording apparatus, special paper for only the inkjet recording apparatus having a high water-absorbing property is known.

The special paper is preferable to form a high quality image; however, the special paper needs to have a water absorbing layer which results in a higher cost.

On the contrary, normal paper which is generally used for copying an image is low cost; however, a high quality image is not formed due to a low water-absorbing property.

In addition, a coated paper whose cost is lower than the normal paper is well known. In the coated paper, in order to have a gloss on the paper, a coating material is applied onto the surface of the paper, and an image having a high chromogenic property can be formed on the coated paper. However, since the water-absorbing property is very low, the coated paper cannot be used to form a high quality image. In particular, an image quality is likely to be lowered due to beading by condensing ink on the coated paper.

In order to restrain the beading which occurs when the coated paper is used, the following methods have been used.

In a first method, ink is prevented from being condensed so that the ink is widely dispersed on the paper by not being adhered to a specific part of the paper and dots of the ink are not overlapped as much as possible. Specifically, small size dots and medium size dots are used to form a halftone pattern, and large size dots are dispersed on the paper (see Patent Document 1). In another method of the first method, after determining positions of dots, arbitrary dots are dispersed to positions separated from other dots as much as possible (see Patent Document 2). In another method of the first method, large size dots and small size dots are positioned in corresponding checkered patterns, respectively, and the ink is prevented from being condensed (see Patent Document 3).

In a second method, while maintaining the adhering amount of ink onto the paper, after passing a predetermined time in which dots of ink are absorbed into the paper, adjacent dots are adhered onto the paper. With this, the beading is prevented (see Patent Documents 4 and 5). That is, a time difference is determined between first dot ejection and second (adjacent) dot ejection.

In a third method, a mechanism for detecting an ink status on the paper is provided, and ink ejection is controlled by the detected status. With this, excessive adhering of the ink onto the paper is prevented (see Patent Document 6).

As other methods, a method has been proposed in which a heating mechanism for drying ink after forming an image on the paper is provided, and another method has been proposed in which a material to increase an adhering property of ink on the paper is used.

[Patent Document 1] Japanese Laid-Open Patent Application Publication No. 2007-151089

[Patent Document 2] Japanese Laid-Open Patent Application Publication No. 2006-050596

[Patent Document 3] Japanese Laid-Open Patent Application Publication No. 2003-333330

[Patent Document 4] Japanese Laid-Open Patent Application Publication No. 2006-123523

[Patent Document 5] Japanese Laid-Open Patent Application Publication No. 2006-272730

[Patent Document 6] Japanese Laid-Open Patent Application Publication No. 2001-239654

However, in the first method in which the dots of the ink are dispersed on the paper, when the method is assumed to be used in a printer which is low cost with low accuracy for forming an image, ink adhering positions are shifted from target positions due to the low accuracy for obtaining the target positions. Consequently, the beading likely occurs with condensation of ink at a specific position. In order to solve the above problem, the beading can be prevented by lowering the amount of ink to be adhered onto the paper. However, in this case, the image may have a blank line on the image since the lack of the target amount of ink. In the second method in which the time difference is determined between the first dot ejection and the second dot ejection, high-speed printing may not be performed in a printer.

In the third method in which a specific mechanism is provided in a apparatus, the apparatus may be high cost and large sized. In the other method in which the specific material is used in addition to the ink, the cost of the apparatus may be increased.

### SUMMARY OF THE INVENTION

In a preferred embodiment of the present invention, there is provided an image forming method and an inkjet recording apparatus using the method in which a dither matrix is selected for increasing image quality against beading while maintaining a sufficient high-speed printing function and restraining from being high cost.

Features and advantages of the present invention are set forth in the description that follows, and in part will become apparent from the description and the accompanying drawings, or may be learned by practice of the invention according to the teachings provided in the description. Features and advantages of embodiments of the present invention will be realized and attained by an image forming method and an inkjet recording apparatus using the method particularly pointed out in the specification in such full, clear, concise, and exact terms so as to enable a person having ordinary skill in the art to practice the invention.

To achieve one or more of these and other advantages, according to one aspect of the present invention, there is provided an image forming method in an inkjet recording apparatus, which uses L (L≧1) kinds of ink, includes a recording head capable of ejecting “n” sizes of ink droplets M[n] (n≧1), and records an image on a recording medium by separating a tone forming region on the recording medium when the sizes of the ink droplets are determined to be M[1], M[2], . . . in order from the smallest size. When beading is generated by ink droplets M[i] (i≧1) or more, the image forming method includes the steps of forming a halftone pattern by arraying dots of the ink droplets in a mesh type or a line type with a fixed pitch in the ink droplets M[j] (j≧i), and not ejecting the ink droplets M[j] onto all pixel positions of the recording medium other than the positions of the halftone pattern.

### EFFECT OF THE INVENTION

According to an embodiment of the present invention, in an image forming method, the sizes and the positions of ink droplets of ink on a recording medium are controlled so that a pattern can be observed as a halftone pattern even if beading is generated in the pattern. With this, even if coated paper whose cost is low and water absorbing property is low is used, a high quality image can be formed on the recording medium while maintaining a high-speed printing function.

### BRIEF DESCRIPTION OF THE DRAWINGS

Features and advantages of the present invention will become more apparent from the following detailed description when read in conjunction with the accompanying drawings, in which:

FIG. 1 is a schematic diagram showing a structure of an inkjet recording apparatus according to an embodiment of the present invention;

FIG. 2 is a diagram showing a main part of the inkjet recording apparatus shown in FIG. 1;

FIG. 3 is a perspective view of a recording head in the inkjet recording apparatus shown in FIG. 1;

FIG. 4 is a schematic diagram showing a part of a carrying belt in the inkjet recording apparatus shown in FIG. 1;

FIG. 5 is a diagram showing liquid droplet ejecting operations from the recording head shown in FIG. 1;

FIG. 6 is a block diagram showing a control section of the inkjet recording apparatus shown in FIG. 1;

FIG. 7 is a block diagram showing a printer driver shown in FIG. 6;

FIG. 8 is a diagram showing the sizes of ink droplets according to the embodiment of the present invention;

FIG. 9 is a diagram showing an image on paper shown in FIG. 1 by using medium size ink droplets equal to a resolution pitch of the inkjet recording apparatus shown in FIG. 1;

FIG. 10 is a diagram showing an image on the paper shown in FIG. 1 by using large size ink droplets greater than the resolution pitch of the inkjet recording apparatus shown in FIG. 1;

FIG. 11 is a diagram showing an image on the paper by using small size ink droplets smaller than the resolution pitch of the inkjet recording apparatus shown in FIG. 1;

FIG. 12 is a diagram showing an image on the paper by using the small size ink droplets when ejecting positions of the ink droplets are offset from target positions;

FIG. 13 is a diagram showing a halftone pattern formed by using one color of one dot size ink droplets;

FIG. 14 is a diagram showing a halftone pattern formed by using two colors of one dot size ink droplets;

FIG. 15 is a diagram showing a halftone pattern formed by using one color of two dot size ink droplets;

FIG. 16 is a diagram showing a halftone pattern formed by using two colors of two dot size ink droplets;

FIG. 17 is a diagram showing a halftone pattern formed by a mesh dither process in the image forming method according to the embodiment of the present invention;

FIG. 18 is a diagram showing a halftone pattern formed by a line dither process in the image forming method according to the embodiment of the present invention;

FIG. 19 is a diagram showing a halftone pattern formed by a dispersion dither process in the image forming method according to the embodiment of the present invention;

FIG. 20 is a diagram showing a halftone pattern formed by an error dispersion process in the image forming method according to the embodiment of the present invention; and

FIG. 21 is a diagram showing patterns when two colors of ink are used.

### DESCRIPTION OF THE PREFERRED EMBODIMENT

### Best Mode of Carrying Out the Invention

The best mode of carrying out the present invention is described with reference to the accompanying drawings.

An inkjet recording apparatus according to an embodiment of the present invention uses L (L >1) kinds of ink and includes a recording head capable of ejecting “n” (n≧1) kinds of ink droplets M[n] from recording nozzles. When the ink droplets are determined to be M[1], M[2], . . . in order from the smallest size of the ink droplets, a tone forming region is separated depending on the ink droplet sizes M[n] in the inkjet recording apparatus.

When ink droplets which generate beading are M[i] (i≧1) or more, ink droplets M[j] (j≧1) are arrayed in a mesh type or a line type with a fixed pitch, and a halftone pattern in which dots are arrayed is formed. The ink droplets M[j] are not always recorded at all pixel positions in a tone expression, and are recorded so that the halftone pattern remains.

First, referring to the drawings, the inkjet recording apparatus according to the embodiment of the present invention is described.

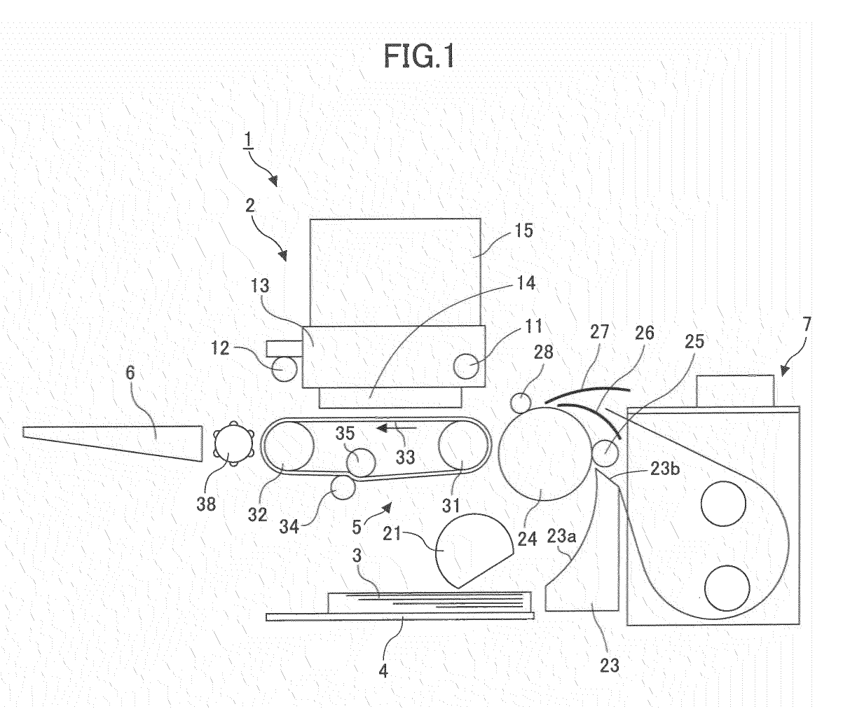

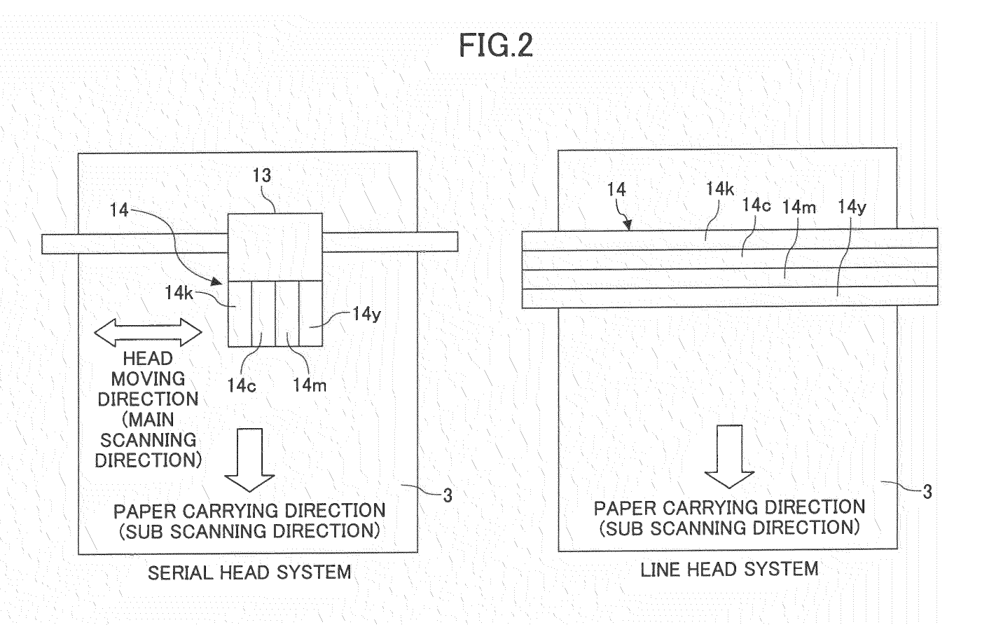

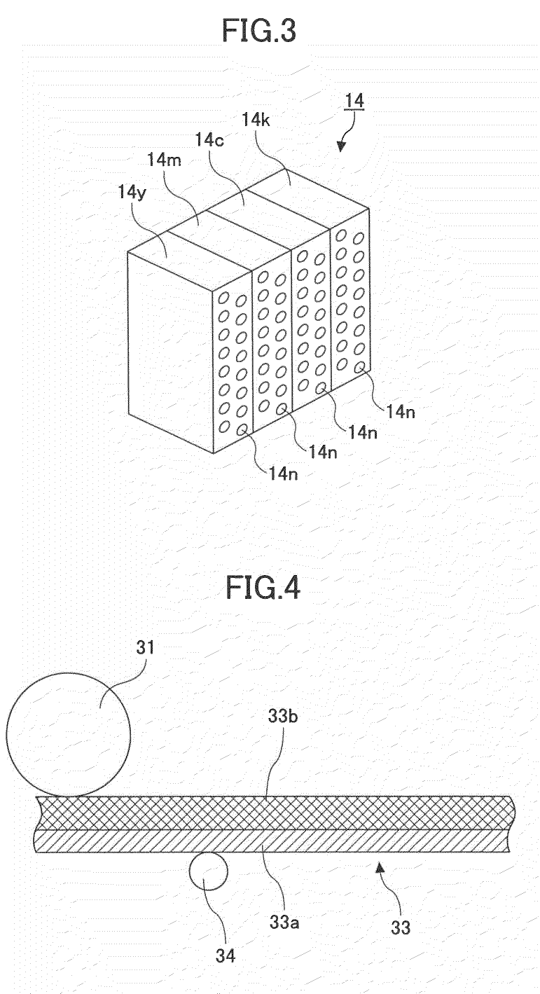

FIG. 1 is a schematic diagram showing a structure of the inkjet recording apparatus according to the embodiment of the present invention. FIG. 2 is a diagram showing a main part of the inkjet recording apparatus shown in FIG. 1. FIG. 3 is a perspective view of a recording head in the inkjet recording apparatus shown in FIG. 1. FIG. 4 is a schematic diagram showing a part of a carrying belt in the inkjet recording apparatus shown in FIG. 1.

The inkjet recording apparatus includes an image forming section 2 in an apparatus main body 1, and a paper feeding tray 4 for storing paper 3 (recording medium) at a lower part of the apparatus main body 1. In the inkjet recording apparatus, the paper 3 from the paper feeding tray 4 is carried by a paper carrying mechanism 5, an image is formed on the paper 3 by the image forming section 2, and the paper on which the image is formed is output to a paper outputting tray 6 at a side of the apparatus main body 1.

The inkjet recording apparatus further includes a duplex print unit 7 detachable from the apparatus main body 1. When double-sided printing is performed on the paper 3, after printing an image on one surface (front surface) of the paper 3, the paper 3 is carried by the paper carrying mechanism 5 in the inverse direction and is input to the duplex print unit 7. The duplex print unit 7 inverts the surface of the paper 3 and feeds the paper 3 to the paper carrying mechanism 5. The image forming section 2 forms another image on the other surface (rear surface) of the paper 3 and the paper 3 is output to the paper outputting tray

In the image forming section 2, a carriage 13 is slidably held by guide shafts 11 and 12, and the carriage 13 is moved in the main scanning direction orthogonal to the paper carrying direction by a main scanning motor (not shown).

A recording head 14 is installed in the carriage 13. The recording head 14 is formed of a liquid droplet ejecting head in which nozzle holes 14n (see FIG. 3) for ejecting liquid droplets (ink droplets) are arrayed. An ink cartridge 15 for supplying ink to the recording head 14 is detachably attached to the recording head 14.

Instead of using the ink cartridge 15, a sub tank can be attached to the recording head 14, and ink is supplied to the sub tank from a main tank.

As shown in FIGS. 2 and 3, the recording head 14 can be formed of four inkjet heads 14y, 14m, 14c, and 14k. The inkjet head 14y ejects yellow “Y” ink droplets, the inkjet head 14m ejects magenta “M” ink droplets, the inkjet head 14c ejects cyan “C” ink droplets, and the inkjet head 14k ejects black “K” ink droplets. However, the recording head 14 can be formed of a single inkjet head or plural inkjet heads having plural nozzle arrays for ejecting corresponding color ink droplets. In addition, the number of colors and the arraying order of the inkjet heads are not limited to the above.

In addition, the inkjet recording apparatus according to the embodiment of the present invention can use either a serial head system shown in FIG. 2(a) or a line head system shown in FIG. 2(b). In the line head system, the nozzle arrays are positioned in the direction orthogonal to the paper carrying direction, and the length of the nozzle array is approximately the width of the paper 3.

As an energy generating unit for ejecting ink droplets from the inkjet head, a piezoelectric actuator using piezoelectric elements, a thermal actuator, a shape-memory-alloy actuator, an electrostatic actuator using an electrostatic force, and so on can be used. In the thermal actuator, an electro-thermal conversion element such as a heat generating resistor is used, and a phase change caused by film boiling of liquid is utilized. In the shape-memory-alloy actuator, a metal phase change caused by a temperature change is used.

As the electro-thermal conversion element, an electro-thermal conversion element having non-linear characteristics is preferable in which a resistance value is hardly changed when a low voltage is applied and the resistance value is largely changed when a predetermined voltage or more is applied.

In an electro-thermal conversion element having linear characteristics, when plural heat generating units are selectively driven, a noise voltage is applied to a non-selected heat generating unit. Consequently, energy is wasted, or the amount of ink droplets to be ejected is changed due to a change of a driving voltage, and a recorded image is changed.

In particular, in an inkjet head which selectively drives the heat generating units disposed in a matrix shape at intersecting points of plural longitudinal direction wirings and plural lateral direction wirings by applying voltages to the wirings, there is a risk that a voltage lower than a driving voltage is applied to the unselected heat generating units. When the voltage is a forward direction voltage, an unnecessary heat is generated in the unselected heat generating units. When the unnecessary heat is accumulated and heat is generated at the time of ejection of ink droplets, the heat is generated beyond necessity; consequently, ink is excessively ejected. As a result, the ink ejecting amounts are dispersed in each nozzle.

On the contrary, when an electro-thermal conversion element having non-linear characteristics is used, even if a voltage such as noise lower than a driving voltage is applied to the unselected heat generating units, an unnecessary heat is not generated in the unselected heat generating units and the dispersion of the ejecting amount of ink is prevented. With this, the granularity of the ink on the paper 3 can be high and the tone of the image can be sufficiently formed on the paper 3. In addition, since the unnecessary heat generation is prevented, energy is not wasted.

In addition, when a resistance value of each electro-thermal conversion element is measured, a driving voltage to be applied to each electro-thermal conversion element can be adjusted.

In particular, when the inkjet head has a long-length shape, the resistance values of the electro-thermal conversion elements are likely dispersed; consequently, the ink amount to be ejected from the inkjet head is dispersed. However, when the resistance value of each electro-thermal conversion element is fed back, a voltage to be applied can be adjusted and an ink droplet having an ideal size can be ejected.

When the electro-thermal conversion element (ejecting energy generating element) is used, a protection layer can be formed on the electro-thermal conversion element. When the protection layer is formed, erosion of the element by ink, kogation in which substances are stacked on the surface of the element, cavitation which breaks the element by bubbles are not directly applied to the electro-thermal conversion element. With this, since the damage of the electro-thermal conversion element is prevented, the service life of the electro-thermal conversion element can be long.

Each piece of paper 3 in the paper feeding tray 4 is fed to the paper carrying mechanism 5 one by one by being separated by a paper feeding roller 21 (half-moon roller) and a separation pad (not shown).

The paper carrying mechanism 5 includes a guiding section 23, a paper carrying roller 24, a pressure applying roller 25, a first guiding member 26, a second guiding member 27, and a pushing roller 28. The guiding section 23 guides the paper 3 fed from the paper feeding tray 4 along a first guiding surface 23, and guides the paper 3 output from the duplex print unit 7 along a second guiding surface 23b. The paper carrying roller 24 carries the paper 3 guided by the guiding section 23. The pressure applying roller 25 pushes the paper 3 on the paper carrying roller 24. The first guiding member 26 guides the paper 3 carried between paper carrying roller 24 and the pressure applying roller 25 to the side of the pushing roller 28. The second guiding member 27 guides the paper 3 to the duplex print unit 7 when double-sided printing is performed. The pushing roller 28 pushes the paper 3 on the paper carrying roller 24.

The paper carrying mechanism 5 further includes a driving roller 31, a driven roller 32, a carrying belt 33, a charging roller 34, a guiding roller 35, a guiding member (not shown), and a cleaning roller (not shown). The carrying belt 33 is wound around the driving roller 31 and the driven roller 32 so that the paper 3 is carried by being maintained to be flat for the recording head 14. The charging roller 34 charges the carrying belt 33. The guiding roller 35 guides the carrying belt 33 by facing the charging roller 34. The guiding member is a platen plate and guides the carrying belt 33 at a position facing the image forming section 2. The cleaning roller is formed of a porous material and removes remaining recording liquid (ink) from the carrying belt 33.

The carrying belt 33 is an endless belt and is moved in the arrow direction (paper carrying direction) shown in FIG. 1.

The carrying belt 33 can have a single layer structure, a double layer structure, or a structure having three or more layers. In FIG. 4, the double layer structure of the carrying belt 33 is shown and the carrying belt 33 is formed of a first layer 33a (front layer) and a second layer 33b (rear layer). The first layer 33 is a surface where the paper 3 is adhered.

For example, the carrying belt 33 can be formed of a front layer made of, for example, an ETFE pure material having approximately 40 μm thickness to which resistance control is not applied and a rear layer (medium resistance value layer; ground layer) made of the same material as that of the front layer to which the resistance control is applied by using carbon.

The charging roller 34 contacts the carrying belt 33 and is rotated by the movement of the carrying belt 33. A high voltage is applied to the charging roller 34 from a high-voltage power source (not shown) by having a predetermined pattern.

In addition, a paper outputting roller 38 is at the downstream side of the paper carrying mechanism 5. The paper outputting roller 38 outputs the paper 3 on which an image is formed to the paper outputting tray 6.

The carrying belt 33 contacts the charging roller 34 to which a high voltage is applied while the carrying belt 33 is moved in the arrow direction, and is charged to be positive. When polarity of the charging roller 34 is switched with a predetermined time interval, the carrying belt 33 is charged with a predetermined charging pitch.

When the paper 3 is carried on the carrying belt 33 charged to be a high voltage, the inside of the paper 3 is polarized, electric charges having polarity reverse to electric charges on the carrying belt 33 are generated on the surface of the paper 3 contacting the carrying belt 33. With this, the paper 3 is electrostatically adhered onto the carrying belt 33 by an electrostatic force between the electric charges on the carrying belt 33 and the paper 3.

With this, warping and unevenness of the paper 3 are corrected by being strongly adhered onto the carrying belt 33 and the surface of the paper 3 is highly flattened.

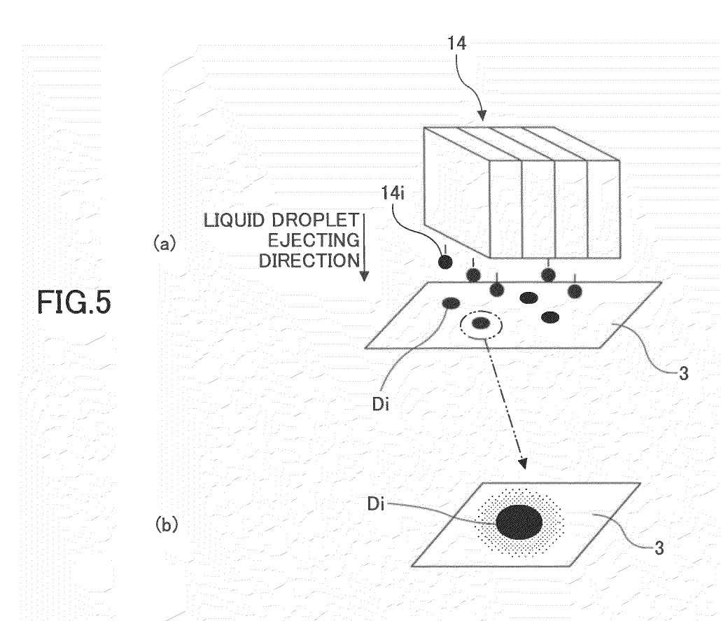

The paper 3 is moved by the carrying belt 33 and the recording head 14 is driven corresponding to image signals while the carriage 13 is moved in one direction or both directions. At this time, as shown in FIG. 5, when the recording head 14 ejects a liquid droplet 14i (ink droplet), a dot Di is formed by the liquid droplet 14i on the stopping paper 3. When one line of an image is formed on the paper 3, the paper 3 is moved by a predetermined distance, and the next line of an image is formed on the paper 3. When a record completion signal or a signal that the back-end of the paper 3 reaches a non-recording region is generated, image recording on the paper 3 is completed. FIG. 5(a) shows the operations and FIG. 5(b) is an enlarged view of a part of the dot Di.

As described above, the paper 3 on which an image is formed is output to the paper outputting tray 6 by the paper outputting roller 38.

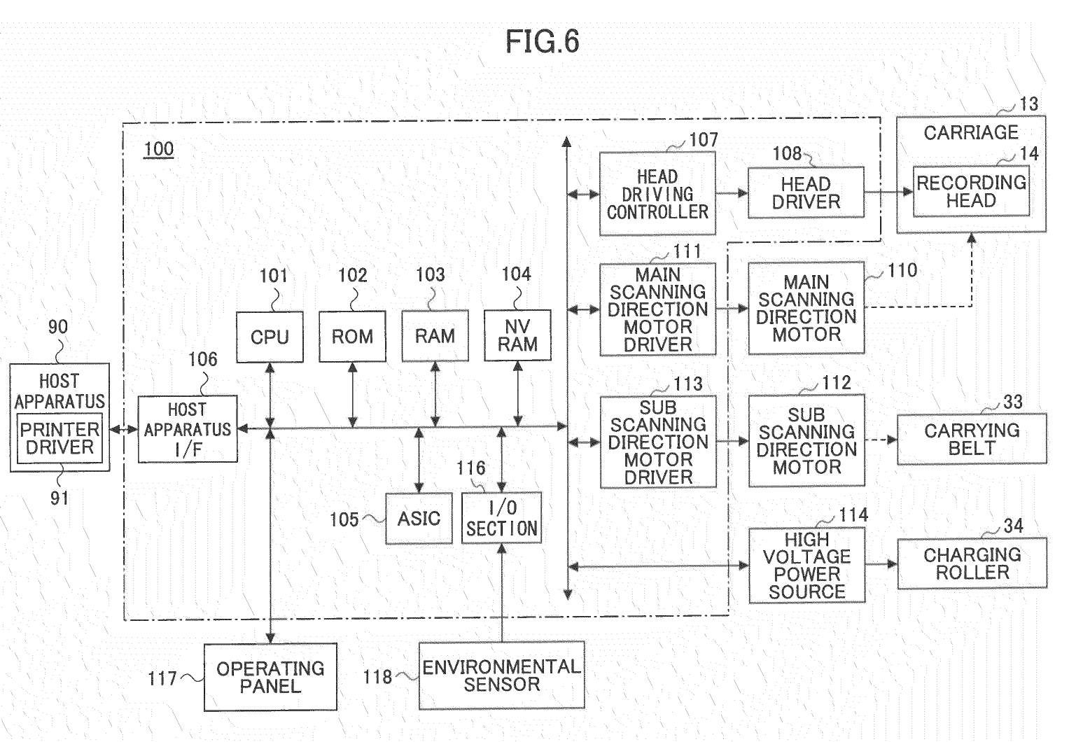

Next, referring to FIG. 6, a control section for controlling operations of the inkjet recording apparatus is described. FIG. 6 is a block diagram showing a control section 100 of the inkjet recording apparatus.

As shown in FIG. 6, the control section 100 includes a CPU (central processing unit) 101, a ROM (read only memory) 102, a RAM (random access memory) 103, an NVRAM (non-volatile RAM) 104, and an ASIC (application specific integrated circuit) 105. The CPU 101 controls operations of the apparatus. The ROM 102 stores programs which are executed by the CPU 101 and data such as fixed data. The RAM 103 temporarily stores image data and so on. The NVRAM 104 stores data while the power source of the apparatus is tuned off. The ASIC 105 processes signals such as image signals, input signals, and output signals for controlling the apparatus.

The control section 100 further includes a host apparatus I/F (interface) 106, a head driving controller 107, a head driver 108, a main scanning direction motor driver 111, a sub scanning direction motor driver 113, a subsystem driver (not shown), an environmental sensor 118, and an I/O (input/output) section 116. The host apparatus I/F 106 receives/transmits data and signals from/to a host apparatus 90 which is, for example, an image processing apparatus. The head driving controller 107 and the head driver 108 drive and control the recording head 14. The main scanning direction motor driver 111 drives a main scanning direction motor 110, and the sub scanning direction motor driver 113 drives a sub scanning direction motor 112. The subsystem driver drives a motor of a subsystem (not shown). The environmental sensor 118 detects ambient temperature and/or ambient humidity. Signals detected by the environmental sensor 118 are input to the I/O section 116.

In addition, an operating panel 117 is connected to the control section 100 and a user inputs an instruction and necessary information to the inkjet recording apparatus on the operating panel 117, and necessary information for the user is displayed on the operating panel 117.

Further, the control section 100 has functions to control turning on/off a high voltage power source 114 which applies a high voltage to the charging roller 34 and to control switching output polarity from the high voltage power source

The control section 100 receives print data including image data from the host apparatus 90 via a cable, or a network at the host apparatus I/F 106. The host apparatus 90 is an image processing apparatus such as a personal computer, an image reading apparatus such as an image scanner, an image taking apparatus such as a digital camera, and so on.

A printer driver 91 in the host apparatus 90 generates print data and outputs the print data to the host apparatus I/F 106 in the control section 100.

The CPU 101 reads the print data from a receiving buffer in the host apparatus I/F 106, analyzes the print data, causes the ASIC 105 to change a data sequence of the analyzed data, and sends the data to the head driving controller 107.

In order to output an image, in the conversion of the print data into bitmap data, the printer driver 91 in the host apparatus 90 converts the image data into the bitmap data and the bitmap data are sent to the control section 100. However, the control section 100 can execute the conversion by installing font data in, for example, the ROM 102.

When the head driving controller 107 receives image data (dot pattern data) of one line of the recording head 14, the head driving controller 107 sends the dot pattern data of one line as serial data to the head driver 108 by synchronizing with a clock signal, and also sends a latch signal to the head driver 108 at a predetermined timing.

The head driving controller 107 includes a ROM which stores pattern data of a driving waveform (driving signal), and a driving waveform generating circuit formed of a waveform generating circuit including a D/A (digital to analog) converter which converts driving waveform data read from the ROM into analog data and an amplifier. The ROM can be the ROM 102.

The head driver 108 includes a shift register, a latch circuit, a level shifter, and an analog switch array (switching unit). The clock signal and the serial data (image data) from the head driving controller 107 are input to the shift register. The latch circuit latches a register value of the shift register by a latch signal from the head driving controller 107. The level shifter shifts the level of a value output from the latch circuit. The analog switch array is controlled between on and off by the level shifter. The head driver 108 drives the recording head 14 by selectively applying a predetermined driving waveform in the driving waveforms to an actuator of the recording head 14 by controlling on/off of the analog switch array.

The inkjet recording apparatus according to the embodiment of the present invention has a function to print an image on the paper 3 without having a blank space at least at a part of borders of the paper 3.

When an image is printed on a border of the paper 3, ink droplets must be ejected outside the border of the paper 3. That is, even if the ink droplets are ejected to the border of the paper 3, actually, in many cases, due to errors of the paper carrying mechanism 5 and driving errors of the carriage 13, the ink droplets are not ejected to a target position. In order to solve the above problem, by considering the errors, the ink droplets are ejected outside the border of the paper 3.

Since the ink droplets ejected outside the border of the paper 3 does not contribute to the recording, the ink droplets are wastefully consumed. In order to decrease the amount of the wasteful ink droplets, it is effective that the paper carrying accuracy is made to be high.

Specifically, when an image is printed on a border of the paper 3, the paper carrying accuracy is made to be high by finely carrying the paper 3.

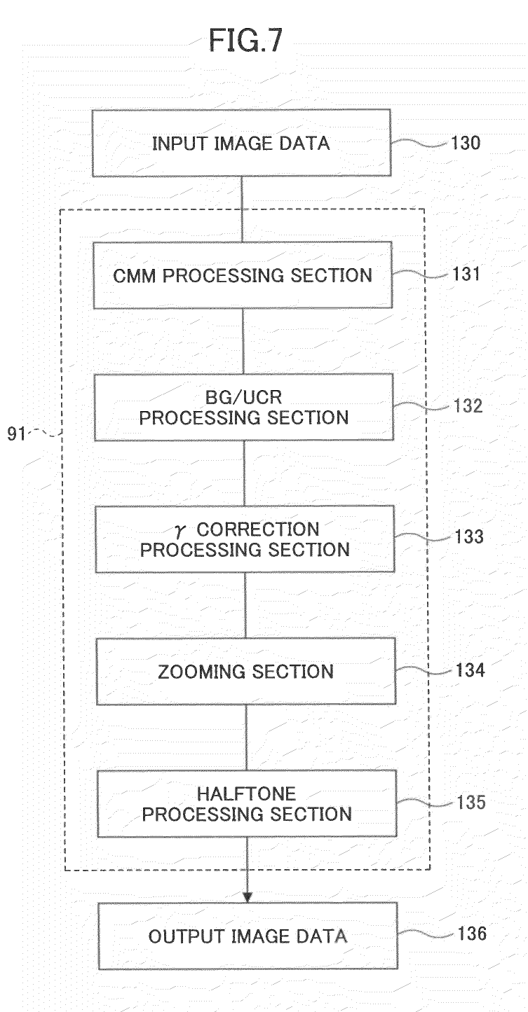

Next, referring to FIG. 7, the printer driver 91 in the host apparatus 90 (image processing apparatus) is described. The host apparatus 90 transmits image data to the image forming apparatus and the image forming apparatus forms an image on the paper 3.

As shown in FIG. 7, the printer driver 91 includes a CMM (color management module) processing section 131, a BG/UCR (black generation/under color removal) processing section 132, a y correction section 133, a zooming section 134, and a halftone processing section 135. The printer driver 91 receives input image data 130 given from application software and so on and outputs processed (output) image data 136.

The CMM processing section 131 converts the input image data 130 from a color space for monitor displaying into a color space for recording (from RGB values into CMY values). The BG/UCR processing section 133 applies a black generation process and an under color removal process to the CMY values. The y correction section 133 applies an input/output correction to the image data output from the BG/UCR processing section 132 by considering recording apparatus characteristics and user taste. The zooming section 134 applies an enlarging process to image data based on the resolution of the recording apparatus. The halftone processing section 135 includes a multi-level and single-level matrix and converts the image data into dot patterns to be ejected from the recording apparatus.

Next, the recording liquid (ink) which is used in the inkjet recording apparatus is described. As a color material of the ink, a pigment or a dye can be used, and also a material mixed the pigment with the dye can be used.

Constituents of the recording liquid (ink) are described.

[Pigment]

The kind of the pigments is not particularly limited. However, the following pigments are preferably used, and the pigments can be mixed.

As an organic pigment, there are, for example, an azo pigment, a phtalocyanine pigment, an anthraquinone pigment, a quinacridone pigment, a dioxazine pigment, an indigo pigment, a thioindigo pigment, a perylene pigment, an isoindolinone pigment, aniline black, an azomethine pigment, a rhodamine B lake pigment, and carbon black.

As an inorganic pigment, there are, for example, an iron oxide pigment, a titanium oxide pigment, a calcium carbonate pigment, a barium sulfate pigment, an aluminum hydroxide pigment, a barium yellow pigment, an iron blue pigment, a cadmium red pigment, a chrome yellow pigment, and a metal powder pigment.

The particle diameter of the pigment is preferably 0.01 to 0.03 μm. When the particle diameter is less than 0.01 μm, the particle diameter is approximated to the particle diameter of dyes, and light resistance is lowered and feathering is increased. In addition, when the particle diameter is more than 0.03 μm, the nozzles of the recording head 14 may be clogged and a filter in a printer may be clogged. That is, ejection of ink droplets is not stably performed.

As the carbon black which is used in black pigment ink, the following carbon black formed by a furnace method or a channel method is preferable. In the carbon black, the primary particle diameter is 15 to 40 milli-micron, the specific surface area by BET method is 50 to 300 m²/g, the DBP oil absorbing amount is 40 to 150 ml/100 g, volatile components are 0.5 to 10%, and the pH value is 2 to 9.

For example, No. 2300, No. 900, MCF-88, No. 33, No. 40, No. 45, No. 52, MA7, MA8, MA100, and No. 2200B of Mitubishi Chemical; Raven 700, Raven 5750, Raven 5250, Raven 5000, Raven 3500, and Raven 1255 of Columbia; Regal 1400R, Regal 330R, Regal 660R, Mogul L, Monarch 700, Monarch 800, Monarch 880, Monarch 900, Monarch 1000, Monarch 1100, Monarch 1300, and Monarch 1400 of Cabot; and Color Black FW1, Color Black FW2, Color Black FW2V, Color Black FW18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4 of Degussa can be used.

As described above, as specific examples of the color organic pigments, there are an azo pigment, a phtalocyanine pigment, an anthraquinone pigment, a quinacridone pigment, a dioxazine pigment, an indigo pigment, a thioindigo pigment, a perylene pigment, an isoindolinone pigment, aniline black, an azomethine pigment, a rhodamine B lake pigment, carbon black, and so on. In addition, as specific examples of the color inorganic pigments, there are, for example, an iron oxide pigment, a titanium oxide pigment, a calcium carbonate pigment, a barium sulfate pigment, an aluminum hydroxide pigment, a barium yellow pigment, an iron blue pigment, a cadmium red pigment, a chrome yellow pigment, and a metal powder pigment.

When the pigments are exemplified in each color, there are the following pigments.

As the pigments for yellow ink, there are, for example, C.I. Pigment Yellow 1, 2, 3, 12, 13, 14, 16, 17, 73, 74, 75, 83, 93, 95, 97, 98, 114, 128, 129, 151, and 154. However, the pigments are not particularly limited to the above.

As the pigments for magenta ink, there are, for example, C.I. Pigment Red 5, 7, 12, 48(Ca), 48(Mn), 57(Ca), 57:1, 112, 123, 168, 184, and 202. However, the pigments are not particularly limited to the above.

As the pigments for cyan ink, there are, for example, C.I. Pigment Blue 1, 2, 3, 15:3, 15:34, 16, 22, 60, and C.I. Bat Blue 4, and 60. However, the pigments are not particularly limited to the above.

As the pigments which are used in the embodiment of the present invention, a pigment which is newly developed for the present invention can be used.

The pigments described above can be inkjet recording liquid when the pigments are dispersed in an aqueous medium by using a polymer dispersant or a surfactant.

As the dispersant for dispersing organic pigment powders in the aqueous medium, general water-soluble resin and a water-soluble surfactant can be used.

As the examples of the water-soluble resin, there are, for example, styrene, styrene derivative, vinylnaphtalene derivative; saturated fatty chain alcohol ester of a, β-ethylene calboxylic acid; block copolymer, random copolymer, or acid formed of at least two or more monomers selected from acrylic acid, acrylic acid derivative, maleic acid, maleic acid derivative, itacomic acid, itacomic acid derivative, fumarate, and fumarate derivative.

The water-soluble resin is alkaline-soluble type resin in an aqueous solution in which acid is dissolved and is preferable when the weight average molecular weight is 3000 to 200000. That is, when the water-soluble resin is used for the inkjet recording liquid, the viscosity of the dispersant can be lowered and the inkjet recording liquid can be easily dispersed.

When the polymer dispersant and a self-dispersion type pigment are used, a suitable dot diameter can be obtained.

When the polymer dispersant is contained in the inkjet recording liquid, penetration of the inkjet recording liquid into recording paper is prevented. On the other hand, condensation of the self dispersion type pigment is prevented by the polymer dispersant. With this, the self dispersion type pigment can be smoothly diffused on the recording paper. Consequently, the dots are diffused widely and thinly and suitable dots can be formed.

As examples of the water-soluble surfactants which are used as the dispersant, the following surfactants can be used.

For example, as anion surfactants, there are, for example, higher fatty acid salt, alkyl sulfate, alkyl ether sulfate, alkyl ester sulfate, alkyl aryl ether sulfate, alkyl sulfonate, sulfosuccinate, alkyl allyl and alkyl naphthalene surfonate, alkyl phosphate, polyoxyehylene alkyl ether phosphate ester salt, and alkyl allyl ether phosphate.

In addition, as cation surfactants, there are, for example, alkyl amine salt, dialkyl amine salt, tetra alkyl ammonium salt, benzal conium salt, alkyl pyridinium salt, and imidazolium salt.

Further, as anion and cation surfactants, there are, for example, dimethyl alkyl lauyl betaine, alkyl glycine, alkyl diglycine, and imidazolinium betaine.

In addition, as the nonionic surfactants, there are, for example, polyoxy ethylene alkyl ether, polyoxy ethelene alkyl allyl ether, polyoxy ethylene polyoxy propylene glycol, glycerin ester, sorbitan ester, sucrose ester, polyoxy ethelene ether of glycerin ester, polyoxy ethelene ether of sorbitan ester, polyoxy ethelene ether of sobitol ester, fatty acid alkanolamide, polyoxy ethylene fatty acid amide, amine oxide, and polyoxy ethelene alkyl amine.

In addition, when the pigment is made to be a microcapsule by being coated by resin having a hydrophilic group, the pigment can have a high dispersing property.

There are several existing methods in which the water-insoluble pigment is made to be a microcapsule by being coated by an organic polymer. In the embodiment of the present invention, any one of the existing methods can be used. As the existing methods, there are a chemical method, a physical method, a physical-chemical method, and a mechanical method.

Specifically, there are an interfacial polymerization method, an in-situ polymerization method, a film coating and hardening in liquid method, a coacervation method, a drying in liquid method, a melting dispersion cooling method, a mixing in air coating method, a spray drying method, an acid deposition method, and a phase shift emulsifying method.

In the interfacial polymerization method, two kinds of monomers or two kinds of reactants are separately dissolved into a disperse phase and a continuous phase, and a wall film is formed by making both substances react at the boundary surface (interface).

In the in-situ polymerization method, a liquid or gas monomer and a catalyst, or two kinds of reactive substances is supplied from one of the continuous phase core particle sides, and a wall film is formed by the reaction of the substances. In the film coating and hardening in liquid method, a droplet of a polymer solution including core substance particles is made to be insoluble in liquid by a hardener and a wall film is formed. In the coacervation method, a polymer dispersant in which core substance particles are dispersed is divided into a coacervate (condensed phase) and a diluted phase, and a wall film is formed. In the drying in liquid method, liquid is prepared in which core substances are dispersed in a wall-film substance solution, a dispersion liquid is input to the prepared liquid in which the continuous phase is not mixed and composite emulsion is formed, and a wall film is formed by gradually removing a substance which is dissolving the wall-film substance. In the melting dispersion cooling method, by using a substance which is melted into liquid by applying heat and is hardened in room temperature, the substance is melted by heat and core substance particles are dispersed in the melted substance, and a wall film is formed by cooling fine particles. In the mixing in air coating method, powdered core substance particles are mixed into air (gas), wall film coating liquid is sprayed while the particles are floating, and a wall film is formed. In the spray draying method, capsule raw liquid is sprayed and the sprayed liquid is contacted with hot air, and a wall film is formed by evaporating and drying volatile components. In the acid deposition method, at least a part of a anion group containing an organic polymer is neutralized in an acid compound, and water-soluble property is given, and mixed in water together with a color material, the substance is neutralized or made to be acid, an organic compound is deposited and adhered to the color material, and neutralization and dispersion are applied. In the phase shift emulsifying method, an organic solvent phase is formed by an anion organic polymer having a dispersing property and a color material, water is added to the organic solvent phase or, the organic solvent phase is input to water, and a wall film is formed.

As the organic polymers (resin) to form the wall film of the microcapsule, the following materials are exemplified.

That is, there are, for example, polyamide, polyurethane, polyester, polyurea, epoxy resin, polycarbonate, ureaformaldehyde resin, melamine resin, phenol resin, polysaccharide, gelatin, gum Arabic, dextran, casein, protein, natural rubber, carboxy polymethlene, polyvinyl alcohol, polyvinyl pyrolidone, poly acetate, vinyl, polyvinyl chloride, polyvinylidene chloride, cellulose, ethylcellulose, methylcellulose, cellulose nitride, hydroxyethyl cellulose, cellulose acetate, polyethylene, polystyrene, polymer or copolymer of (meta)acrylic acid, polymer or copolymer of (meta)acrylic acid ester, styrene-maleic acid copolymer, algin acid soda, fatty acid, paraffin, bees wax, water wax, hardened beef fat, carnauba wax, and albumin.

From the above, an anion organic polymer in a carboxylic acid group or a sulfonic acid group can be used.

In addition, as nonionic organic polymers, there are, for example, polyvinyl alcohol, polyethleneglycol monomethacrylate, polypropylene glycol monomethacrylate, methoxy polyethleneglycolmonometacrylate and (co)polymer of the above, and cationic ring-opening polymer of 2-oxazoline.

In particular, a perfect hydrolyzed compound of polyvinyl alcohol has a low water-soluble property and is soluble in high temperature water and is not soluble in low temperature water, which is preferable.

The amount of the organic polymer of which the wall film of the microcapsule is formed is preferably 1 wt % or more and 20 wt % or less for a water-insoluble color material such as an organic pigment or carbon black. When the amount is within the above range, the content rate of the organic polymer in the capsule is relatively low. Therefore, lowering the chromogenic property of the pigment caused by covering the pigment surface by the organic polymer can be prevented.

When the amount of the organic polymer is less than 1 wt %, the capsule does not work well, and when the amount of the organic polymer is more than 20 wt %, the chromogenic property of the pigment is remarkably lowered.

When the other characteristics of the pigment is assumed, the amount of the organic polymer is more preferably in the range of 5 to 10 wt % for a water-insoluble color material.

That is, a part of the color material is substantially exposed without being covered; therefore, the lowering the chromogenic property of the color material is prevented. On the contrary, a part of the color material is not substantially covered without being exposed; the pigment can be substantially covered by the surface of the capsule.

The number average molecular weight of the organic polymer is preferably 2000 or more when the manufacturing method of the capsule is assumed. In the above, the substantial exposure is not a part of exposure such as a pinhole or a crack caused by a defect, but signifies an intentional exposure state.

In addition, as the color material, when a self-dispersion type organic pigment or self-dispersion type carbon black is used, even if the content rate of the organic polymer in the capsule is relatively low, the dispersion property of the pigment is increased. Therefore, the preservation stability of the ink can be sufficiently obtained.

The organic polymer is selected corresponding to the selected microcapsule forming method.

In the interfacial polymerization method, polyester, polyamide, polyurethane, polyvinyl pyrroridone, and epoxy resin are preferable. In the in-situ polymerization method, a polymer or a copolymer of (meta)acrylic acid ester, copolymer of (meta)acrylic acid-(meta)acrylic acid ester, copolymer of styrene-(meta)acrylic acid, polyvinyl chloride, polyvinylidene chloride, and polyamide are preferable.

In the film coating and hardening in the liquid method, algin acid soda, polyvinyl alcohol, gelatin, albumin, epoxy resin, and the like is preferable. In the coacervation method, gelatin, celluloses, casein, and so on is preferable.

In order to form a fine and uniform microcapsule, another existing method can be used.

When the phase shift emulsifying method or the acid deposition method is used, as the organic polymer for forming the wall film of the microcapsule, an anion organic polymer is used.

In the phase shift emulsifying method, an organic solvent phase is formed as a composite body in which an anion organic polymer having a self-dispersing property or a dissolving property for water is combined with a color material such as a self-dispersion organic pigment or self-dispersion carbon black; or an organic solvent phase is formed as a mixed body in which a color material such as a self-dispersion organic pigment or self-dispersion carbon black is mixed with a hardener or an anion organic polymer. Then, water is added to the organic solvent phase, and thereafter, the organic solvent phase is added to water. With this, a microcapsule is formed by phase shifting emulsion.

In the phase shift emulsifying method, a vehicle for recording liquid or an additive can be mixed into the organic solvent phase. In particular, since dispersion liquid for recording is directly formed, it is preferable that the vehicle for recording liquid be mixed in.

In the acid deposition method, an aqueous cake is formed by neutralizing a part or all parts of a anion group containing organic polymer by an acid compound, mixing a color material such as a self-dispersion organic pigment or self-dispersion carbon black in a aqueous medium, depositing an anion containing organic polymer by making a pH value neutral or acidic in the acid compound, and adhering the anion organic polymer to the pigment. Then, a microcapsule is formed by neutralizing a part or all parts of the anion organic polymer of the aqueous cake by using the acid compound. With this, aqueous dispersion liquid containing an anion microcapsule pigment including many fine pigments can be formed.

As a solvent which is used to form the microcapsule, there are, for example, alkyl alcohol group such as methanol, ethanol, propanol, butanol, an aromatic hydrocarbon group such as benzole, toluole, xylole, an ester group such as ethyl acetate, methyl acetate, and butyl acetate; a chlorinated hydrocarbon group such as chloroform and ethylene dichloride; a ketone group such as acetone and methyl isobutyl ketone; an ether group such as tetrahydrofuran and dioxane; and a cellosolve group such as methyl cellosolve and butyl cellsolve.

The microcapsules formed by the above method are separated from the solvent with use of a centrifugal separation method or a filtration method, and the separated microcapsules are agitated with water and a suitable solvent. With this, the microcapsules are dispersed in liquid and recording liquid is obtained. In this case, the average particle diameter of the microcapsule pigment is preferably 50 to 180 nm.

As described above, when a pigment is coated by resin, the pigment can be surely adhered onto the paper 3, and the pigment is prevented from being scraped.

[Dye]

As the recording dye, a dye classified into an acid dye, a direct dye, a basic dye, a reactive dye, a food dye in the color index having a water resistant property and a light resistant property can be used.

As the dye, a plural-dye mixed dye or a dye mixed with another color material such as a pigment can be used.

As the acid dyes and the food dyes, there are C.I. acid yellow 17, 23, 42, 44, 79, and 142; C.I. acid red 1, 8, 13, 14, 18, 26, 27, 35, 37, 42, 52, 82, 87, 89, 97, 106, 111, 114, 115, 134, 186, 249, 254, and 289; C.I. acid blue 9, 29, 45, 92, and 249; C.I. acid black 1, 2, 7, 24, 26, and 94; C.I. food yellow 3 and 4; C.I. food red 7, 9, and 14; and C.I. food black 1 and 2.

As the direct dyes, there are C.I. direct yellow 1, 12, 24, 26, 33, 44, 50, 86, 120, 132, 142, and 144; C.I. direct red 1, 4, 9, 13, 17, 20, 28, 31, 39, 80, 81, 83, 89, 225, and 227; C.I. direct orange 26, 29, 62, and 102; C.I. direct blue 1, 2, 6, 15, 22, 25, 71, 76, 79, 86, 87, 90, 98, 163, 165, 199, and 202; and C.I. direct black 19, 22, 32, 38, 51, 56, 71, 74, 75, 77, 154, 168, and 171.

As the basic dyes, there are C.I. basic yellow 1, 2, 11, 13, 14, 15, 19, 21, 23, 24, 25, 28, 29, 32, 36, 40, 41, 45, 49, 51, 53, 63, 64, 65, 67, 70, 73, 77, 87, and 91; C.I. basic red 2, 12, 13, 14, 15, 18, 22, 23, 24, 27, 29, 35, 36, 38, 39, 46, 49, 51, 52, 54, 59, 68, 69, 70, 73, 78, 82, 102, 104, 109, and 112; C.I. basic blue 1, 3, 5, 7, 9, 21, 22, 26, 35, 41, 45, 47, 54, 62, 65, 66, 67, 69, 75, 77, 78, 89, 92, 93, 105, 117, 120, 122, 124, 129, 137, 141, 147, and 155; and C.I. basic black 2 and 8.

As the reactive dyes, there are C.I. reactive black 3, 4, 7, 11, 12, and 17; C.I. reactive yellow 1, 5, 11, 13, 14, 20, 21, 22, 40, 47, 51, 55, 65, and 67; C.I. reactive red 1, 14, 17, 25, 26, 32, 37, 44, 46, 55, 60, 66, 74, 79, 96, and 97; and C.I. reactive blue 1, 2, 7, 14, 15, 23, 32, 35, 38, 41, 63, 80, and 95.

[Common Additive for Dye and Pigment]

In order to make the recording liquid have a predetermined solid state property or to prevent the nozzles of the recording head from being clogged, a water-soluble solvent is preferably used in addition to the above color material.

The water-soluble solvent has functions as a wetting agent and a penetrating agent.

The wetting agent function prevents the nozzles of the recording head from being clogged by being dried.

As the wetting agents, there are, for example, polyalcohol, polyalcohol alkyl ether, polyalcohol aryl ether, nitrogen heterocyclic compound, amido, amine, sulfur compounds, propylene carbonate, carbon ethylene, and γ-butyrolactone.

As the polyalcohol, there are, for example, ethylene glycol, diethylene glycol, triethylene glycol, tetraethylene glycol, polyethylene glycol, propylene glycol; 1,3-butanediol; 1,3-propanediol; 2-methyl-1,3-propanediol; 1,4-butanediol; 1,5-pentanediol; 1,6-hexanediol; glycerin; 1,2,6-hexanetriol; 2-ethyl-1,3-hexanediol; 1,2,4-butantriol; 1,2,3-butantriol; and polyol.

As the polyalcohol alkyl ether, there are, for example, ethylene glycol mono ethyl ether, ethylene glycol mono butyl ether, diethylene glycol mono methyl ether, diethylene glycol mono ethyl ether, diethylene glycol mono butyl ether, triethylene glycol mono butyl ether, tetraethylene glycol mono methyl ether, and propylene ethylene glycol mono ethyl ether.

As the polyalcohol aryl ether, there are, for example, ethylene glycol monophenyl ether, and ethylene glycol monobenzil ether.

As the nitrogen heterocyclic compounds, there are, for example, N-methyl-2-pyrolidone; N-hydroxyethyl-2-pyrolidone; 2-pyrolidone; 1,3-dimethyl imidazolidinone; and ε-caprolactam.

As the amidos, there are, for example, formamide, N-methylformamide, and N-dimetilformamide.

As the amine, there are, for example, monoethanolamine, diethanolamine, triethanolamine, monoethylamine, diethylamine, and triethylamine. As the sulfur compounds, there are, for example, dimethylsulfoxide, sulflane, and thiodiethanol.

The wetting agent function increases the wetting property between the recording liquid and the recording medium (paper), and can adjust the penetrating speed of the recording liquid into the recording medium.

As the penetrating agent, the substances shown by the following Chemical Formulae (I) through (IV) are preferably used.

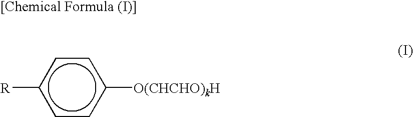

In Chemical Formula (I), R is a branch-able hydrocarbon chain whose carbon number is 6 to 14. In addition, “k” is 5 to 20.

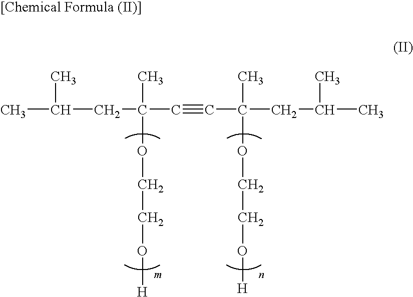

In Chemical Formula (II), “m” is 0 to 40, and “n” is also 0 to 40.

[Chemical Formula (III)]

R—(OCH₂CH₂)nH (III)

In Chemical Formula (III), R is a branch-able hydrocarbon chain whose carbon number is 6 to 14. In addition, “n” is 5 to 20.

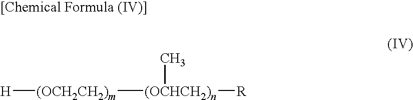

In Chemical Formula (IV), R is a hydrocarbon chain whose carbon number is 6 to 14. In addition, “m” is 20 or less and “n” is also 20 or less.

Chemical Formula (I) shows a polyoxy ethylene alkyl phenyl surfactant, Chemical Formula (II) shows an acetyl glycol surfactant, Chemical Formula (III) shows a polyoxy ethylene alkyl ether surfactant, and Chemical Formula (IV) shows a polyoxy ethylene polyoxy propylene alkyl ether surfactant. The above surfactants have a function to lower the surface tension; therefore, the wetting property of the recording liquid is increased and also the penetrating property of the recording liquid is increased.

In addition to the above compounds, as the surfactants, for example, there are an alkyl group of polyalcohol, an arylether group of polyalcohol, a nonionic surfactant, a fluorine surfactant, and a lower alcohol.

As the alkyl group of polyalcohol and the arylether group of polyalcohol, there are, for example, diethylene glycol mono phenyl ether, ethylene glycol mono phenyl ether, ethylene glycol mono allyl ether, diethylene glycol mono phenyl ether, diethylene glycol mono butyl ether, propylene glycol mono butyl ether, and tetra ethylene glycol chloro phenyl ether. As the nonionic surfactant, there is a copolymer of polyoxy ethylene polyoxy propylene block. As the lower alcohol, there are ethanol and 2-propanol. As the surfactant, the diethylene glycol mono butyl ether is preferable.

The surface tension of the recording liquid is preferably 20 to 60 dyne/cm. Further, in order to obtain the sufficient wetting property and the fine particles of the recording liquid, the surface tension of the recording liquid is more preferably 30 to 50 dyne/cm.

The viscosity of the recording liquid (ink) is preferably 1.0 to 20.0 cP, and is more preferably 3.0 to 10.0 cP when actual ejection stability is obtained.

The pH value of the recording liquid (ink) is preferably 3 to 11, and is more preferably 6 to 10 when a metal member contacting the recording liquid is to be prevented from been actually corroded.

In addition, the recording liquid (ink) can include an antiseptic and a fungicide. With this, the generation and development of bacteria can be prevented over a long time, and the preservation stability of the recording liquid and the image quality stability of the printed image can be obtained.

As the antiseptic and the fungicide, there are, for example, benzotriazole, sodium dehydroacetate, sodium sorbate, 2-pyridinethiol-1-oxidesodium, isothiazolone based compound, sodium benzole, and pentachloro phenolsodium.

In addition, the recording liquid (ink) can include an antirust agent. By using the antirust agent, a film of the antirust agent is formed on a metal surface of, for example, the recording head 14 contacting the ink, and the metal surface is prevented from being rusted.

As the antirust agents, there are, for example, acid sulfite, sodium subsulfite, ammonium thiodiglycolate, diisopropyl ammoniumnitrate, pentaerythnitol tetranitrate, dicyclohexyl ammoniumnitrate.

In addition, the recording liquid can include an antioxidant. By using the antioxidant, even if a radical is generated, the radical can be eliminated and oxidation can be effectively prevented.

As the antioxidants, there are phenol based compounds and amine based compounds.

As the phenol based compounds, there are, for example, a hydroquinone compound, a gallate compound, and hindered based compounds. As the hindered based compounds, there are, for example, 2,6-di-tert-butyl-p-cresol; stearyl-β-(3,5-di-tert-butyl-4-hydoxyphenyl) propionate; 2,2′-methlenebis(4-methyl-6-tert-butylpherol; 2,2′-methlenebis(4-ethyl-6-tert-butylphenol); 4,4′-thiobis(3-methyl-6-tert-buthlphenol); 1,1,3-tris(2-methyl-4-hyydoxy-5-tert-buthylphenol)butane; 1,3,5-trimethyl-2,4,6-tris(3,5-di-tert-4-hydroxybenzyl)benzene; tris(3,5,-di-tert-butyl-4-hydoxybenzyl)isocyanurate; and tetrakis[methlene-3(3′,5′-di-tert-butyl-4-hydroxyphenil)propionate]methane.

As the amine based compounds, there are, for example, N,N′-diphenyl-p-phenylenediamine; phenyl-β-naphthylamine; phenyl-α-naphthylamine; N,N′-β-naphthyl-p-phenylenediamine; N,N′-diphenylethylenediamine; phenothiazine; N,N′-di-sec-butyl-p-phenylenediamine; and 4-4′-tetramethyl-diaminodiphenylmethane.

In addition, a sulfur based compound and a phosphor based compound can be used as the antioxidant. As the sulfur based compounds, there are, for example, dilauryl thiodipropionate, distearyl thiodipropionate, laurylstearyl thidipropionate, dimyristyl thiodiprppionate; distearyl β,β′-thiobutyrate; 2-mercaptobenzoimidazole, and dilaurylsulfide. As the phosphor based compound, there are, for example, triphenyl phosphite, trioctadecyl phosphite, tridecyl phosphite, trilauryltrithio phosphite, diphenylisodecyl phosphite, trinonylphenyl phosphite, and distearylpentaerythritol phosphite.

It is preferable that the pH value of the recording liquid (ink) is arbitrarily adjusted by a pH adjuster. As the pH adjusters, there are, for example, hydroxides of alkali metal elements, ammonium hydroxide, quaternary ammonium hydroxide, quaternary phosphonium hydroxide, amines, alkali metal carbonates, acidum boricum, acidum hydrochloricum, nitric acid, sulfuric acid, and acetic acid. As the hydroxides of the alkali metal elements, there are, for example, lithium hydroxide, sodium hydroxide, and potassium hydroxide. As the alkali metal carbonates, there are, for example, lithium carbonate, and sodium carbonate, potassium carbonate. As the amines, there are, for example, diethanolamine and triethanolamine.

Next, the inkjet recording apparatus and the image forming method according to the present invention are described in detail.

The inkjet recording apparatus according to the embodiment of the present invention uses L (L≧1) kinds of ink and ejects ink droplets having corresponding colors based on an image to be formed.

In addition, in the inkjet recording apparatus, “n” (n≧1) kinds of ink droplets M[n] can be ejected from recording nozzles. When the ink droplets are determined to be M[1], M[2], . . . in order from the smallest size of the ink droplets, the ink droplets can be ejected from the smallest size M[1] in order by separating a tone forming region on a recording medium.

When the ink droplets which generate beading are M[i] (i≧1) or more, ink droplets M[j] (j≧i) are arrayed in a mesh type or a line type with a fixed pitch so that a halftone pattern is formed. When the ink droplets of two or more colors are superimposed, color dots are superimposed on different color dots in the same pattern.

Next, referring to the drawings, processes to form an image are described.

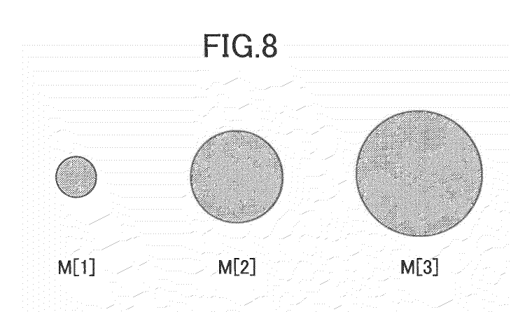

In this example, the number of the sizes of the ink droplets to be ejected from the recording nozzles of the recording head 14 is determined to be three shown in FIG. 8. However, in the embodiment of the present invention, the number of the sizes of the ink droplets is not limited to three and can be four or more.

An image is formed on a recording medium by using the ink droplets shown in FIG. 8 with the same resolution pitch.

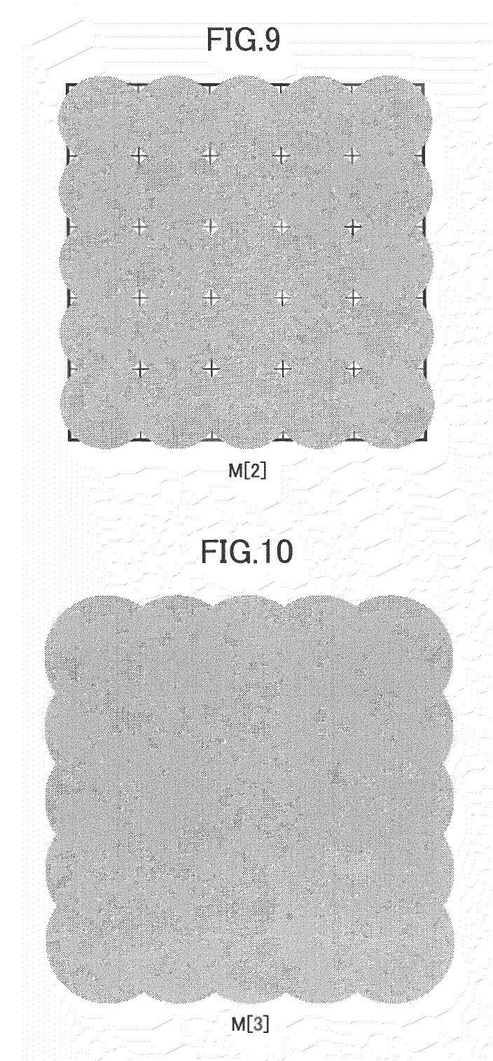

FIG. 9 is a diagram showing an image on the paper 3 by using the ink droplets M[2] equal to the resolution pitch of the inkjet recording apparatus. FIG. 10 is a diagram showing an image on the paper 3 by using the ink droplets M[3] greater than the resolution pitch of the inkjet recording apparatus.

As shown in FIGS. 9 and 10, when coated paper whose water absorbing property is low is used, the adjacent dots are condensed (overlapped) and the beading is generated.

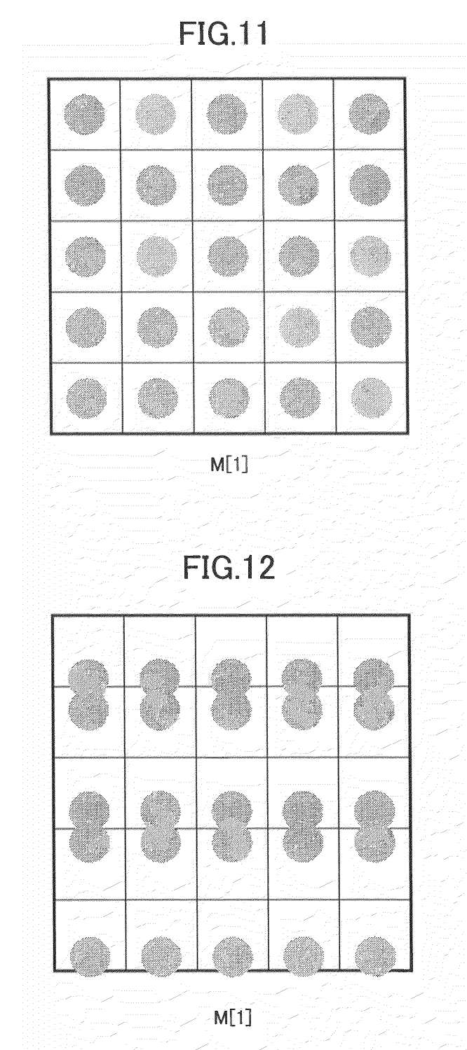

FIG. 11 is a diagram showing an image on the paper 3 by using the ink droplets M[1] smaller than the resolution pitch of the inkjet recording apparatus. As shown in FIG. 11, the beading is not generated.

However, even if the ink droplets M[1] are used, when ejecting positions of the ink droplets are not accurately controlled due to defective positioning control of the inkjet recording apparatus, as shown in FIG. 12, dot positions of the ink droplets are offset from the target positions and the beading may be generated.

That is, the generation of the beading depends on the size of the ink droplets and the ejecting position control.

However, when paper having high water absorbing property is used, even if the ink droplets having the size M[2] or M[3] are ejected, the ink droplets may not be overlapped.

In addition, in the case shown in FIG. 12, even if an inkjet recording apparatus whose ink droplet ejecting accuracy is low is used, when paper having high water absorbing property is used, the ink droplet may not be overlapped. That is, the generation of the beading also depends on the water absorbing property of the paper.

In order to form a high quality image by surely preventing the generation of the beading, in the inkjet recording apparatus, the following image forming processes are used.

In this example, it is assumed that the ink droplets M[1] do not generate the beading even if the ink droplets M[1] are adhered onto all pixels of the paper 3. In addition, the halftone pattern is a mesh pattern. However, in the embodiment of the present invention, the halftone pattern is not limited to the mesh pattern and can be a line pattern. Further, the dot size and the interval between the dots for forming the mesh pattern can be arbitrarily adjusted.

As described above, there is not a risk that the beading is generated by the ink droplets M[1]; however, the beading is generated by the ink droplets M[2] and M[3].

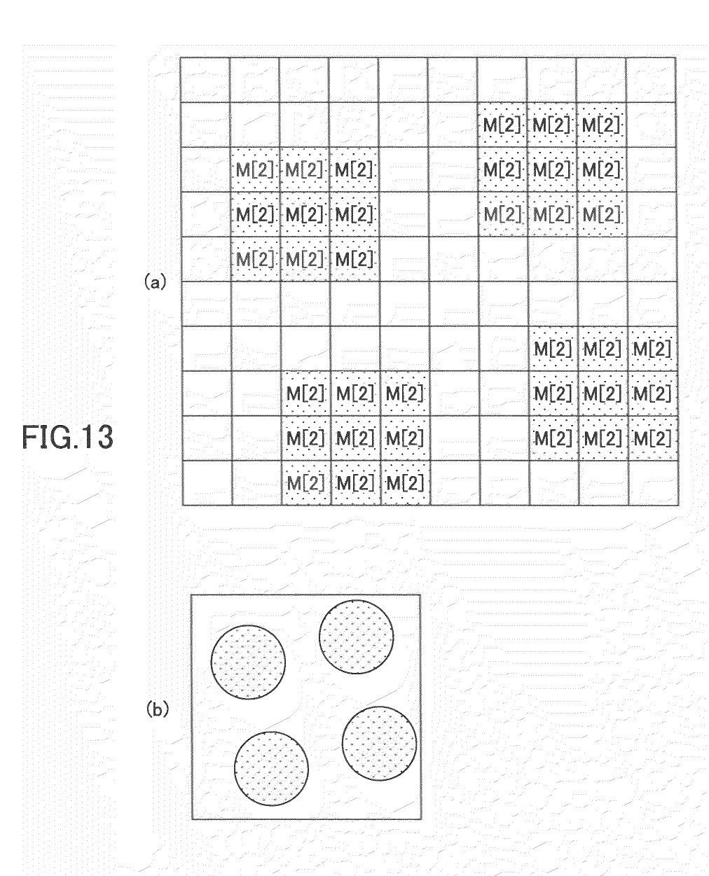

In FIG. 13, the ink droplets M[2] of one color are used. In FIG. 13(a), dots are positioned so that the ink droplets M[2] are ejected to form mesh patterns. In FIG. 13(b), one circle is formed of one mesh pattern.

As shown in FIG. 13(a), the beading is generated at positions where the ink droplets M[2] are ejected onto the paper 3; however, as shown in FIG. 13(b), the pattern can be observed as a halftone pattern of the mesh patterns.

Next, a case is described in which two kinds of ink are used.

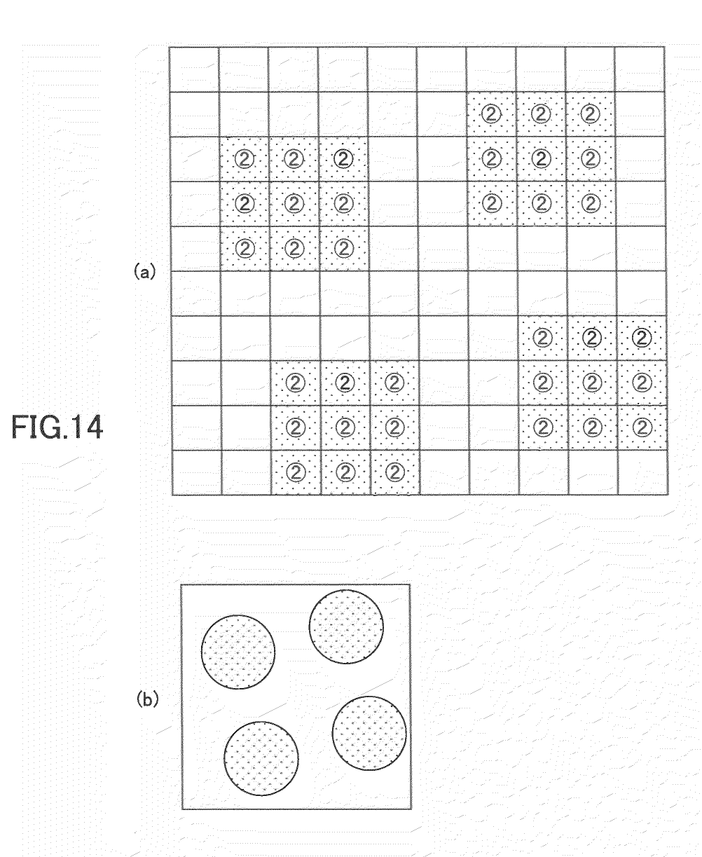

In FIG. 14, the ink droplets M[2] of two colors are used.

As shown in FIG. 14(a), when two different colors of ink droplets M[2] are used and the two color ink droplets M[2] are superimposed as shown in \textcircled{2}, similar to that shown in FIG. 13, even if the beading is generated, it can be observed that the beading is not generated.

In addition, after forming the halftone pattern, when a solid image is formed by the ink droplets M[2] or M[3], the beading is generated. In order to avoid the generation of the beading, it is necessary that the solid image is not formed by the ink droplets M[2] or M[3] and the halftone image must be maintained.

With this, it can be imagined that the beading is not generated in all tones, and the image quality can be prevented from being lowered.

As shown in FIGS. 13 and 14, when the dots are formed by the halftone pattern, pixels where ink is not adhered remain; therefore, there is a risk that a part exists where ink droplets are not ejected in the image.

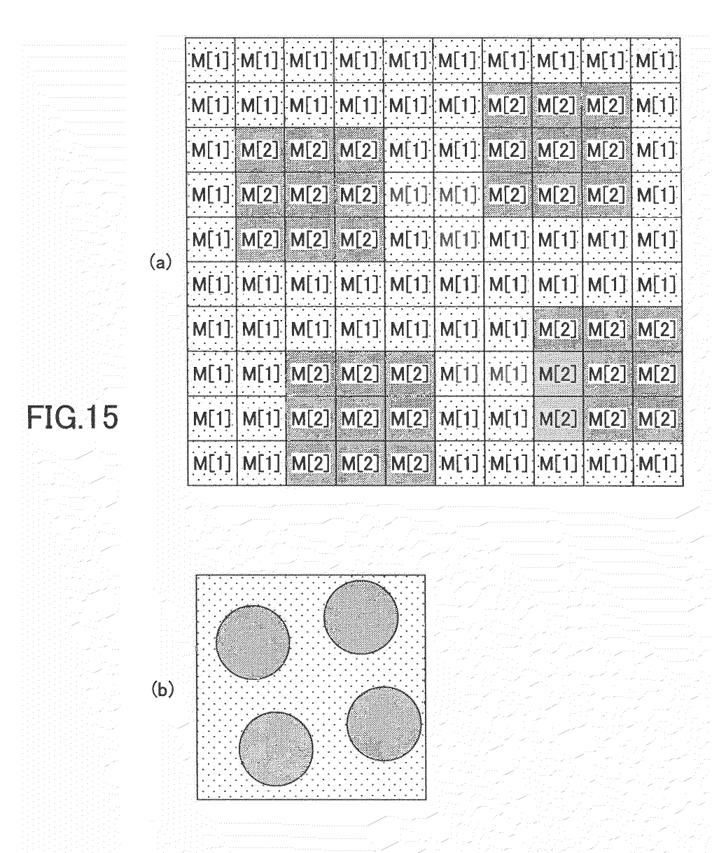

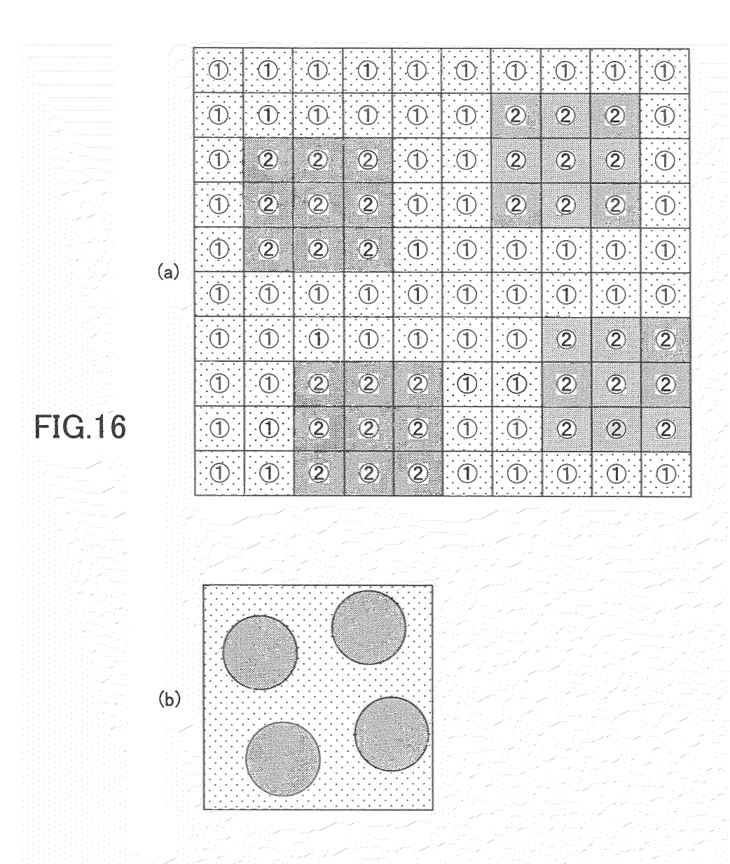

In order to solve the above problem, as shown in FIG. 15, the ink droplets M[1] are ejected onto the pixels where the mesh patterns of the ink droplets M[2] are not formed. In FIG. 15, the ink droplets M[1] and M[2] having the same color are used. In addition, as shown in FIG. 16, the ink droplets M[1] having corresponding different colors are ejected onto the pixels where the mesh patterns of the ink droplets M[2] having the corresponding different colors are not formed.

In FIG. 16, the ink droplets M[1] and M[2] having the corresponding different colors are used.

As shown in \textcircled{2} of FIG. 16, the ink droplets M[2] having a color are superimposed on the ink droplets M[2] having a different color at pixels where mesh patterns are formed, and as shown in \textcircled{1} of FIG. 16, the ink droplets M[1] having a color are superimposed on the ink droplets M[1] having a different color at pixels where mesh patterns are not formed.

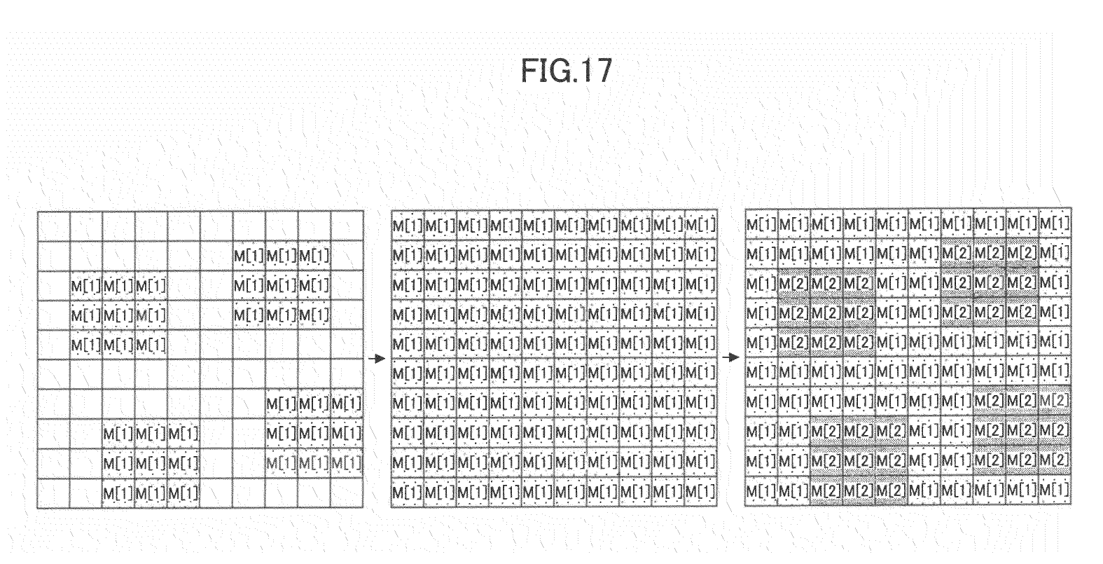

As shown in FIG. 17, when a tone is formed on the paper 3, first, the ink droplets M[1] which do not generate the beading are ejected onto all pixels. With this, the ink droplets M[1] are ejected onto the highlight parts, and a part where the ink droplets are not formed does not exist. In FIG. 17, first, a halftone pattern is formed by the ink droplets M[1], and then a solid pattern is formed by the ink droplets M[1]. Further, the ink droplets M[2] are ejected onto the halftone pattern formed by the ink droplets M[1].

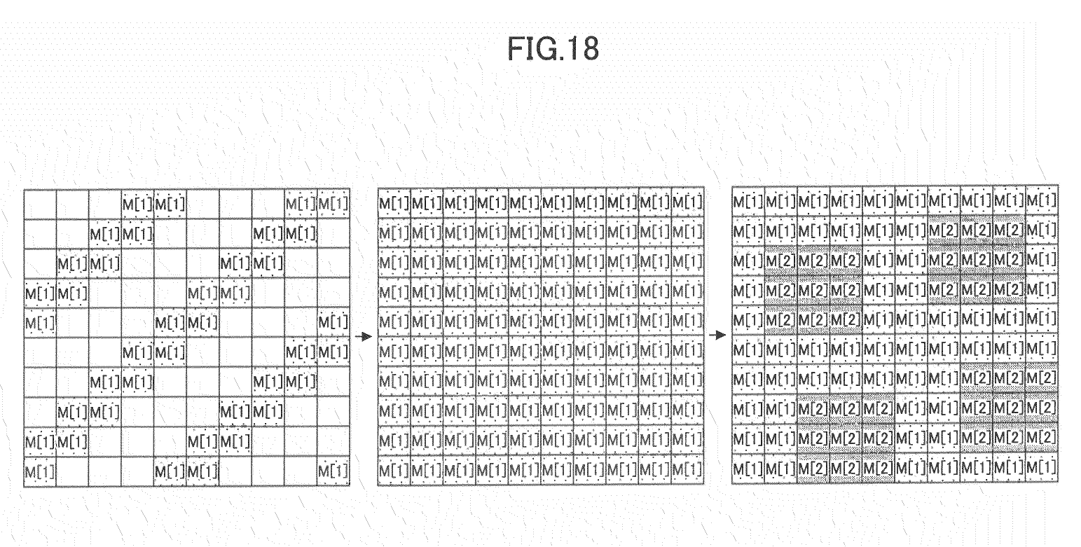

As shown in FIG. 18, when a solid pattern is formed by the ink droplets M[1], first, a line dither pattern of the ink droplets M[1] which do not generate the beading is formed. Then, the solid pattern of the ink droplets M[1] is formed. After this, a halftone pattern of the ink droplets M[2] is formed.

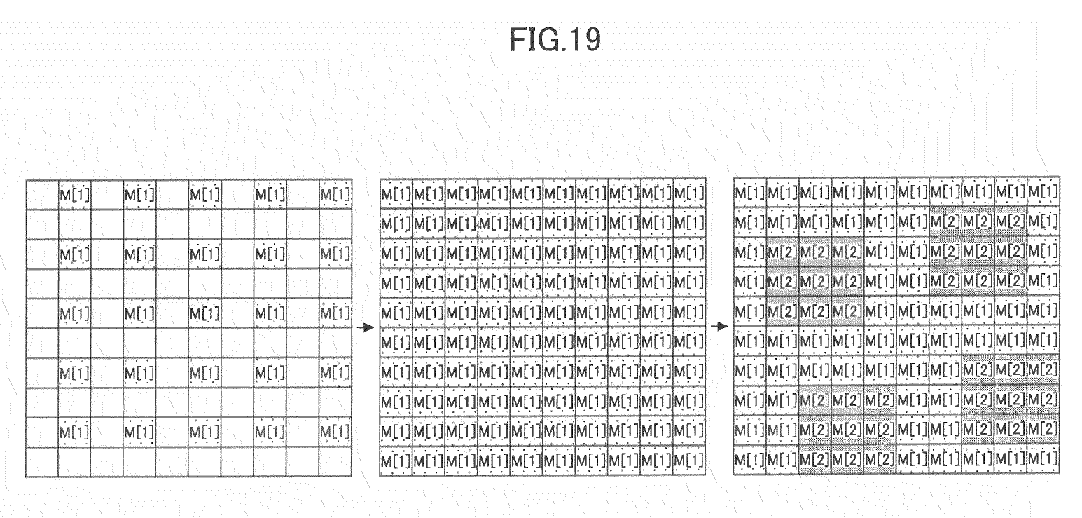

As shown in FIG. 19, when a solid pattern is formed by the ink droplets M[1], first, a dispersion dither pattern of the ink droplets M[1] which do not generate the beading is formed. Then, the solid pattern of the ink droplets M[1] is formed. After this, a halftone pattern of the ink droplets M[2] is formed.

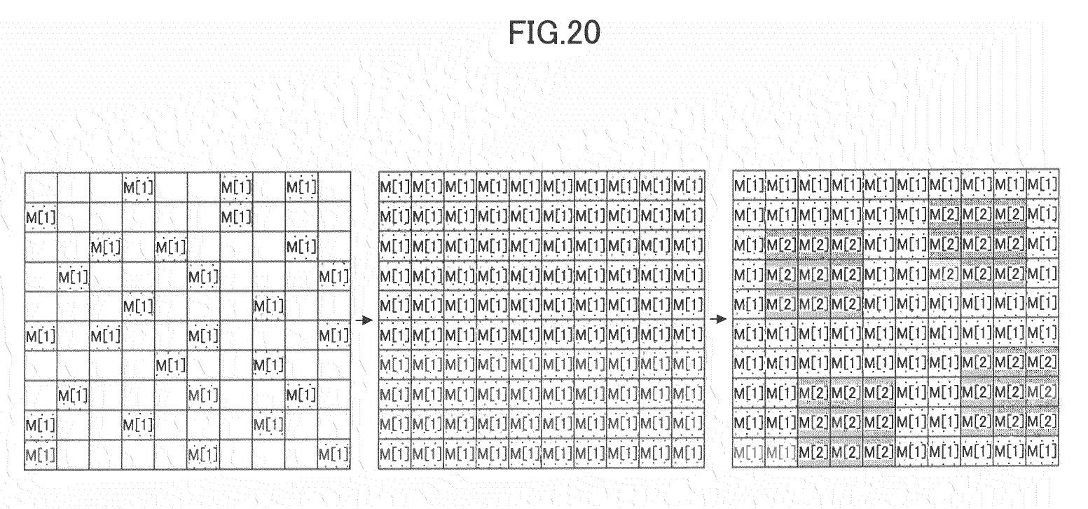

As shown in FIG. 20, when a solid pattern is formed by the ink droplets M[1], first, an error dispersion pattern of the ink droplets M[1] which do not generate the beading is formed. Then, the solid pattern of the ink droplets M[1] is formed. After this, a halftone pattern of the ink droplets M[2] is formed.

That is, in order to avoid a part where the ink droplets are not ejected on the paper 3, several processes which are applied first can be selected. The processes shown in FIGS. 17 through 20 are examples, and hence the image forming method according to the embodiment of the present invention can use another process.

In addition, in order to avoid a part where the ink droplets are not ejected onto the paper 3, the dots are positioned so that the ink droplets M[1] are not overlapped.

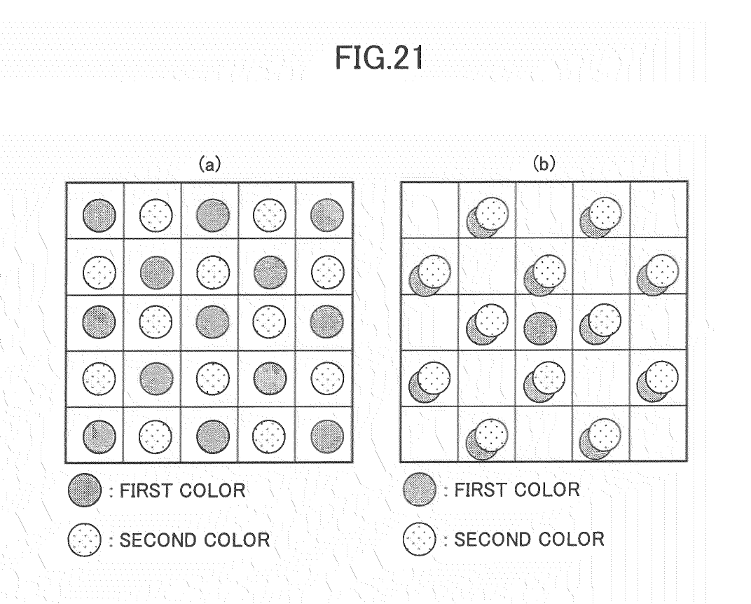

When a mixed color is obtained by combining two colors of ink, as shown in FIG. 21(a), an ink droplet of a first color is not overlapped with an ink droplet of a second color. When an ink droplet of a first color is overlapped an ink droplet of a second color, as shown in FIG. 21(b), there is a risk that a part where the ink droplet does not exist on the paper 3 is generated.

For example, in a case of an inkjet recording apparatus using four colors (kinds) of ink, dots can be positioned so that approximately 25% of each color is not overlapped. With this, a part where the ink droplets are not ejected can be decreased.

In addition, there is a case where the size of ink droplets for forming a halftone pattern is changed due to the using environment of the inkjet recording apparatus and the user's taste. For example, when a solid pattern is formed by the ink droplets M[2] and a halftone pattern is formed by the ink droplets M[3], the inkjet recording apparatus can perform the above case by controlling the printing conditions and adjusting the ejecting positions of the ink droplets.

The image forming method of the inkjet recording apparatus can be realized by a control program which causes a driving signal to transmit to the control section 100 of the inkjet recording apparatus.

The control program can be installed in the inkjet recording apparatus or can be obtained from an information recording medium storing the control program.

In addition, the inkjet recording apparatus according to the embodiment of the present invention can include a computer which processes predetermined information signals by reading an image or can be an independent apparatus which works by being connected to the computer.

As described above, according to the embodiment of the present invention, a high quality image can be obtained without dropping a part of an image on the paper 3.

Further, the present invention is not limited to the specifically disclosed embodiment, and variations and modifications may be made without departing from the scope of the present invention.

The present invention is based on Japanese Priority Patent Application No. 2007-338521, filed on Dec. 28, 2007, with the Japanese Patent Office, the entire contents of which are hereby incorporated herein by reference.

What is claimed is:

1. An image forming method in an inkjet recording apparatus, which uses L (L≧1) kinds of ink, includes a recording head capable of ejecting “n” sizes of ink droplets M[n] (n≧1), and records an image on a recording medium by separating a tone forming region on the recording medium when the sizes of the ink droplets are determined to be M[1], M[2], . . . in order from the smallest size, comprising the steps of:
when beading is generated by ink droplets M[i] (i≧1) or more,
forming a halftone pattern by arraying dots of the ink droplets in a mesh type or a line type with a fixed pitch in the ink droplets M[j] (j≧i); and
not ejecting the ink droplets M[j] onto all pixel positions of the recording medium other than the positions of the halftone pattern.

2. The image forming method as claimed in claim 1, further comprising the step of:
forming a mixed color image on the recording medium by superimposing two or more kinds of color ink droplets on the same pattern.

3. The image forming method as claimed in claim 1, further comprising the steps of:
ejecting ink droplets M[k] (k<i) on all the pixel positions of the recording medium; and
forming a solid image of the ink droplets M[k] on the recording medium with a tone lower than a tone formed by the ink droplets M[i].

4. The image forming method as claimed in claim 1, further comprising the steps of:
forming a halftone pattern by ejecting ink droplets M[k] (k<i) on the recording medium;
forming a solid image of the ink droplets M[k] on the recording medium; and
forming another halftone pattern by ejecting the ink droplets of M[i].

5. The image forming method as claimed in claim 4, wherein:
the halftone pattern formed by the ink droplets M[k] and the halftone pattern formed by the ink droplets M[i] is the same coordinate pattern.

6. The image forming method as claimed in claim 4, wherein:
the halftone pattern formed by the ink droplets M[k] is formed by a dispersion dither method.

7. The image forming method as claimed in claim 4, wherein:
the halftone pattern formed by the ink droplets M[k] is formed by an error diffusion method.

8. The image forming method as claimed in claim 1, wherein:
a mixed color image is formed by positioning different color dots so that both of the same color dots and the different color dots are not overlapped in two or more color dots.

9. The image forming method as claimed in claim 3, wherein:
when a color is formed by combining the L kinds of ink,
in a pattern where the ink droplets M[k] are ejected on the recording medium in a ratio of 1/L, the ink droplets M[k] of the L kinds of the ink are ejected onto corresponding different pixels on the recording medium.

10. An inkjet recording apparatus, which uses L (L≧1) kinds of ink, includes a recording head capable of ejecting “n” sizes of ink droplets M[n] (n≧1), and records an image on a recording medium by separating a tone forming region on the recording medium when the sizes of the ink droplets are determined to be M[1], M[2], . . . in order from the smallest size, wherein:
when beading is generated by ink droplets M[i] (i≧1) or more,
a halftone pattern is formed by arraying dots of the ink droplets in a mesh type or a line type with a fixed pitch in the ink droplets M[j] (j≧i); and
the ink droplets M[j] are not ejected onto all pixel positions of the recording medium other than the positions of the halftone pattern.

11. The inkjet recording apparatus as claimed in claim 10, wherein:
a mixed color image is formed on the recording medium by superimposing two or more kinds of color ink droplets on the same pattern.

12. The inkjet recording apparatus as claimed in claim 10, wherein:
ink droplets M[k] (k<i) are ejected on all the pixel positions of the recording medium; and
a solid image of the ink droplets M[k] is formed on the recording medium with a tone lower than a tone formed by the ink droplets M[i].

13. The inkjet recording apparatus as claimed in claim 10, wherein:
a halftone pattern is formed by ejecting ink droplets M[k] (k<i) on the recording medium;
a solid image of the ink droplets M[k] is formed on the recording medium; and
another halftone pattern is formed by ejecting the ink droplets of M[i].

14. The inkjet recording apparatus as claimed in claim 13, wherein:
the halftone pattern formed by the ink droplets M[k] and the halftone pattern formed by the ink droplets M[i] is the same coordinate pattern.

15. The inkjet recording apparatus as claimed in claim 13, wherein:
the halftone pattern formed by the ink droplets M[k] is formed by a dispersion dither method.

16. The inkjet recording apparatus as claimed in claim 13, wherein:
the halftone pattern formed by the ink droplets M[k] is formed by an error diffusion method.

17. The inkjet recording apparatus as claimed in claim 10, wherein:
a mixed color image is formed by positioning different color dots so that both of the same color dots and the different color dots are not overlapped in two or more color dots.

18. The inkjet recording apparatus as claimed in claim 12, wherein:
when a color is formed by combining the L kinds of ink,
in a pattern where the ink droplets M[k] are ejected on the recording medium in a ratio of 1/L, the ink droplets M[k] of the L kinds of the ink are ejected onto corresponding different pixels on the recording medium.
